(19) United States
(12) Patent Application Publication
(10) Pub. No.: US 2015/0222446 A1
(43) Pub. Date: Aug. 6, 2015

(54) Discovering IP Multicast Group Memberships in Software Defined Networks

(71) Applicants: Beeram Suresh, Bangalore (IN); Balaji Sankaran, Bangalore (IN); Venkatavaradhan Devarajan, Bangalore (IN)

(72) Inventors: Beeram Suresh, Bangalore (IN); Balaji Sankaran, Bangalore (IN); Venkatavaradhan Devarajan, Bangalore (IN)

(21) Appl. No.: 14/414,468

(22) PCT Filed: Sep. 11, 2012
(86) PCT No.: PCT/IN2012/000606

§ 371 Date: Jan. 13, 2015

(51) Int. Cl. H04L 12/18; H04L 12/931

(52) U.S. Cl. CPC H04L 12/185; H04L 49/201

(57) ABSTRACT

Provided is a method of discovering multicast group memberships in a software defined network. A multicast group membership query message is sent only to a selected network device in the network. The network device forwards the multicast group membership query message to a host computer system connected to the network device and recognizes a multicast group membership request from the host computer system in response to the group membership query message.

### BACKGROUND

Multicast technology is being increasingly favored to provide rich content over a network. Multicast is a mechanism for transmitting data from a single source (for example, a server) to multiple receivers (for example, personal computers) on a network. Multicast packets are replicated down appropriate paths in a network to create the most efficient routing mechanism possible. The sender is required to send a data packet only once, even if the packet needs to be delivered to multiple receivers.

### BRIEF DESCRIPTION OF THE DRAWINGS

For a better understanding of the solution, embodiments will now be described, purely by way of example, with reference to the accompanying drawings, in which:

FIG. 1 is a schematic block diagram of a multicast system according to an example.

FIG. 2 is a schematic block diagram of an OpenFlow controller system of FIG. 1, according to an example.

FIG. 3 shows a flow chart of a method, according to an example.

FIG. 4 shows a flow chart of a method of discovering multicast group memberships in a software defined network, according to an example.

FIG. 5 is a schematic block diagram of an OpenFlow controller system hosted on a computer system, according to an example.

### DETAILED DESCRIPTION OF THE INVENTION

Multicast technology is used by organizations to send data (especially, multimedia content) over a network. Multicast packets are forwarded through a network by using a distribution tree. The network replicates a data packet at each node (for example, routers or switches) of the network so that data (or messages) is sent over each node (link) of the network only once. When a receiver joins a multicast group, a multicast distribution tree is constructed for that group. Once a data packet is sent by a sender to a multicast group, it reaches all receivers who have joined the group. Also, the multicast distribution does not require a source to know about the receivers who have joined a multicast group. This makes the mechanism (distribution) extremely efficient in sharing the same information amongst many receivers, thereby improving network utilization in a cost effective way.

In Software Defined Networking (SDN) architecture the control plane is implemented in software separate from the network equipment and the data plane is implemented in the network equipment. OpenFlow is a leading SDN architecture. In OpenFlow network, data forwarding on a network device is controlled through flow table entries populated by an OpenFlow controller that manages the control plane for that network. A network device that receives packets on its interfaces looks up its flow table to check the actions that need to be taken on a received frame. By default an OpenFlow enabled network device creates a default flow table entry to send all packets that do not match any specific flow entry in the table to the OpenFlow Controller. In this manner, the OpenFlow controller becomes aware of all new network traffic coming in on a device and programs a flow table entry corresponding to a new traffic pattern on the receiver network device for subsequent packet forwarding of that flow.

When multicast applications are running on an OpenFlow network, hosts interested in joining an Internet Protocol (IP) multicast group send out multicast group membership requests. An OpenFlow enabled device will by default send these requests to the OpenFlow controller for further processing as there will be no flow table entry matching this traffic pattern. If for some reason this request packet is lost or dropped before the controller could see it, a host does not typically resend the request. In traditional layer 2 networks this problem is addressed by means of electing a specific switch as a querier, which periodically sends out group membership query packets. However, queries send out by a querier flood the entire network thereby wasting network bandwidth.

Proposed is an efficient solution for discovering multicast group memberships in a computer network (for instance, a centralized network or SDN architecture, such OpenFlow) without flooding the entire network with query packets. In an implementation, an OpenFlow controller broadcasts membership query messages to only a subset of network devices and interfaces.

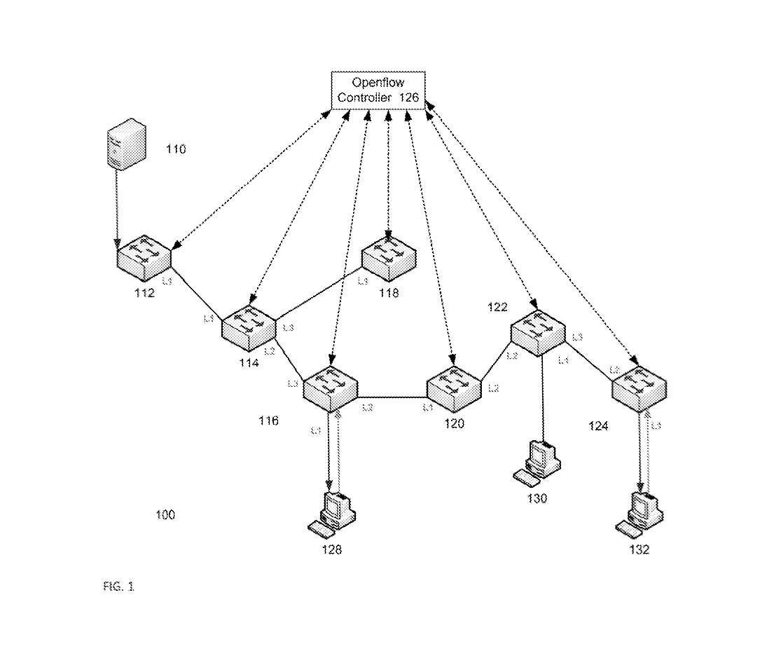

FIG. 1 is a schematic block diagram of a multicast system according to an example.

Multicast system 100 includes a multicast source system 110, network devices 112, 114, 116, 118, 120, 122, 124, OpenFlow controller system 126 and host computer systems 128, 130, 132.

OpenFlow controller system 126 is connected to network devices 112, 114, 116, 118, 120, 122, 124, multicast source system 110 and host computer systems 128, 130, 132 through a network, which may be wired or wireless. The network may be a public network, such as, the Internet, or a private network, such as, an intranet. The number of network devices 112, 114, 116, 118, 120, 122, 124 illustrated in FIG. 1 is by way of example, and not limitation. The number of network devices deployed in a multicast system 100 may vary in other implementations. Similarly, there may be additional multicast source systems, OpenFlow controller systems and host computer systems in other implementations.

Multicast source system 110 is a computing system (for example, a computer server, a desktop computer, and the like) that hosts multicast content. Multicast content may include data, image, audio, video, multimedia, and other like content.

Multicast content may be shared with host computer systems 128, 130, 132 (also known as multicast subscribers) through network devices 112, 114, 116, 118, 120, 122, 124.

Network devices 112, 114, 116, 118, 120, 122, 124 may be, but not limited to, a network switch, virtual switch, or router (for example, an edge router, a subscriber edge router, an Inter-provider Border Router or a core router). In an implementation, network devices 112, 114, 116, 118, 120, 122, 124 are Open-Flow enabled devices. Network devices 112, 114, 116, 118, 120, 122, 124 transfer multicast data from a multicast source to end user systems or devices (multicast receivers).

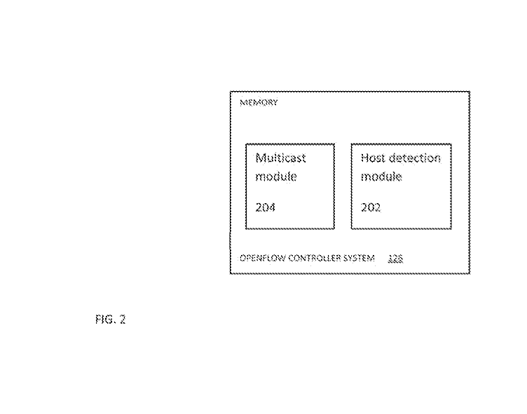

OpenFlow controller system 126 is a computing system (for example, a personal computer, a computer server, and the like) that supports OpenFlow. OpenFlow is an open standard communications protocol that gives access to the forwarding plane of a network switch or router over a network. It provides an open protocol to program a flow table in a network device (such as, a router) thereby controlling the way data packets are routed in a network. Through OpenFlow, the data and control logic of a network device are separated, and the control logic is moved to an external controller such as OpenFlow controller system 126. The OpenFlow controller system 126 maintains all of network rules and distributes the appropriate instructions to network devices 112, 114, 116, 118, 120, 122, 124. It essentially centralizes the network intelligence, while the network maintains a distributed forwarding plane through OpenFlow-enabled network devices. Components of OpenFlow controller system 126 are illustrated in FIG. 2 and described below.

Host computer system 128, 130, 132 may be a desktop computer, notebook computer, tablet computer, computer server, mobile phone, personal digital assistant (PDA), and the like. Host computer system 128, 130, 132 may include a client or multicast application for receiving multicast data from a multicast source system 110. In the context of present disclosure, the term “host computer system” may also include a network device that is interested in a multicast group.

Multicast technology allows only authentic host (or user) computer systems, who have subscribed to a particular content data flow of a content server, to receive the content. Host systems signify their willingness to receive a particular data from a content server by joining a particular multicast group. Once the user systems join a particular group, a multicast distribution tree is created for that group. The flow of data from multicast source system 110 to receiver devices may be managed by a multicast protocol. Some of the most common protocols used to manage flow of data in a multicast system, such as that of FIG. 1, may include, but not limited to, Internet Group Management Protocol (IGMP), Protocol Independent Multicast PIM, and Distance Vector Multicast Routing Protocol (DVMRP).

FIG. 2 is a schematic block diagram of an OpenFlow controller system of FIG. 1, according to an example.

OpenFlow controller system 126 may include and/or support standard OpenFlow controller components. In an implementation, OpenFlow controller system 126 includes host detection module 202 and multicast module 204.

Host detection module 202 identifies all host computer systems and their points of interconnection to a network device. This information is used to decide whether a network device interface is an edge interface or a network interconnect interface. Host detection module 202 can employ many different methodologies for this purpose. In an implementation, host detection module 202 may use Link Layer Discovery Protocol (LLDP) for device identification. LLDP is an IEEE based L2 protocol that is commonly implemented on many end devices like VOIP-phones, video cameras and Linux based desktop machines. All network devices support LLDP as well. Devices that implement LLDP advertise information snippets about themselves like the IP address, system capabilities, MAC address, etc. to their peer devices. One of the information elements advertised is the System Capabilities TLV. With this TLV, the device that is sending LLDP advertisements can communicate to its peer device about its device type. In other words, the device can communicate to its peer whether it is a video capable device, a VOIP Phone, a camera support, a router or a switch, and so and so forth.

When an end device is connected to a network device (for example, a switch) running OpenFlow, LLDP information that the end device advertises to the network device is collected by the default OpenFlow rule and sent to the OpenFlow controller for processing. This LLDP frame received by the controller is passed on to the host detection module 202 which parses the LLDP information and classifies a device connected to a network device as being an end host or a switch based on the capabilities bits set. Therefore, if a device advertises itself as having switching or routing capabilities, it is obviously not an end device. But if these bits aren't set but capability bits like video or voice Call are set, they indicate that the device is an end host.

In this manner, host detection module 202 creates a list of Edge interfaces (may be termed “Edge Interface list”) and a list of network interconnect interfaces (may be termed “Network Device Interconnect Interface list”) for each network device based on the LLDP information received on each device's interfaces. To provide an illustration, in FIG. 1 host computer system 128 is connected to network device 116 on interface L1 and network device 120 is connected to network device 116 on interface L2. In this case, interface L1 on network device 116 is added to Edge Interface list and interface L2 on network device 116 is added to Network Device Interconnect Interface list.

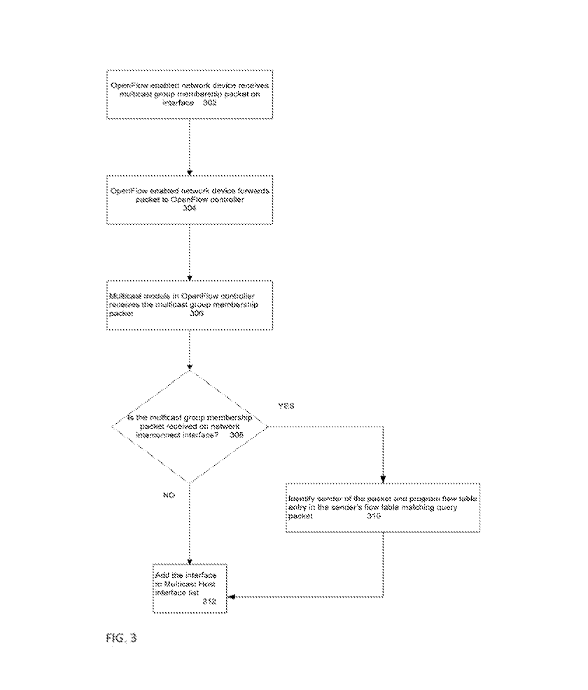

Multicast module 204 of the OpenFlow controller system 126 receives the multicast group membership packets (“multicast group membership requests”) and identifies the network device and its associated interface which is interested in receiving multicast traffic for that group. Multicast module 204 maintains a database of these membership requests and adds the interface on which a network device received a group membership packet to a list which may be termed “Multicast Subscribers Interface list”. FIG. 3 provides a flow chart of the method followed by multicast module 204 for adding an interface to “Multicast Subscribers Interface list”. At block 302, an OpenFlow enabled device (such as 112, 114, 116, 118, 120, 122 or 124) receives a multicast group membership packet on an interface. At block 304, the OpenFlow enabled device forwards the packet to an OpenFlow controller (such as OpenFlow controller system 126). At block 306, a multicast module (such as multicast module 204) of the OpenFlow controller receives the multicast group membership packet. At block 308, multicast module determines whether the multicast group membership packet is received on a network interconnect interface.

If it is determined that the multicast group membership packet is received on a network interconnect interface, the multicast module identifies the sender of the packet from packet info and adds a flow table entry in the sender's flow table to match the query packet (IGMP/MLD) as an output action LOCAL. It then proceeds to add the interface to “Multicast Subscribers Interface list” (block 310). On the other hand, if the multicast group membership packet is not received on a network interconnected interface, the multicast module adds the interface to “Multicast Subscribers Interface list” (block 312).

To provide an illustration of the aforementioned method in the context of FIG. 1, let's consider a scenario wherein host computer system 128 which is connected to network device 116 on interface L1 sends a multicast group membership request. In addition, host stack of network device 120 (connected to network device 116 on Interface L2) also sends a multicast group membership request. In this case, multicast module 204 would add interfaces L1 and L2 on network device 116 to Multicast Subscribers Interface list. Multicast module 204 also checks whether the interface on which network device 116 received a multicast group membership is a network interconnect. If so, multicast module 204 programs a flow table entry matching the query packet in network device 120 flow table (as output action LOCAL) so as to enable the host stack of network device 120 to process a query (for example, Query PKT) sent by OpenFlow controller system 126.

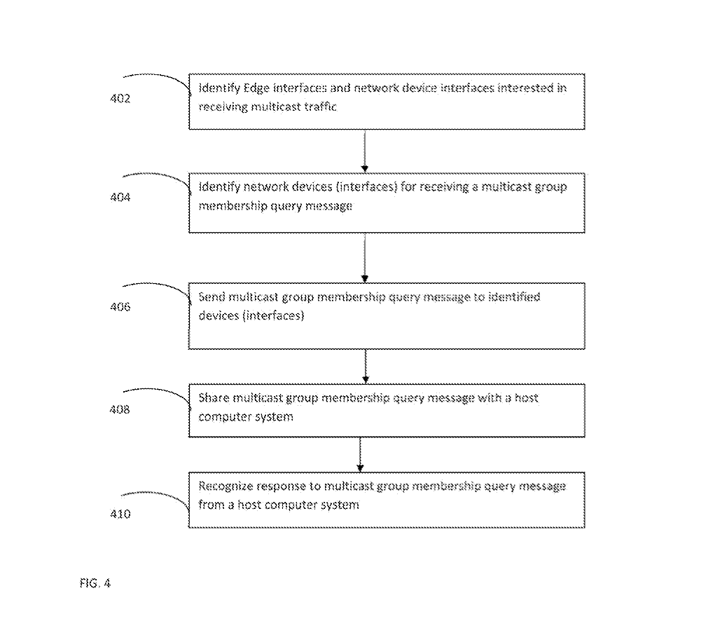

FIG. 4 shows a flow chart of a method of discovering multicast group memberships in an OpenFlow based network (a SDN network). During description references are made to FIG. 1 to illustrate the discovery mechanism. Therefore, in an implementation, the method may be implemented in an OpenFlow based network which may include a multicast source system 110, network devices 112, 114, 116, 118, 120, 122, 124, OpenFlow controller system 126 and host computer systems 128, 130, 132.

At block 402, a multicast module (such as multicast module 204) of an OpenFlow controller (such as OpenFlow controller system 126) obtains the “Edge Interface list” from a host detection module (such as host detection module 202) of the OpenFlow controller. As mentioned earlier, an “Edge Interface list” is a list of Edge interfaces for each network device in a network. In addition, multicast module 204 also obtains a “Multicast Subscribers Interface list”, which, in an implementation, it itself maintains. As mentioned earlier, “Multicast Subscribers Interface list” is a list of network devices and its associated interfaces which are interested in receiving multicast traffic for a multicast group. To illustrate with reference to FIG. 1, multicast module would identify network devices 116 (L1), 116 (12), and 124 (L1) as Multicast Subscribers Interfaces (MSI). Host detection module would identify network devices 116 (L1), 122 (L1), and 124 (L1) as Edge Interfaces (EI).

At block 404, those interfaces of network devices are dentified that would send membership query packets to the subscribers connected to those interfaces. The network devices themselves would receive membership query packets from the OpenFlow controller. These interfaces are identified as follows:

Query Interface (QI) List=(MSI+(EI−MSI)), where MSI is the Multicast Subscribers interfaces (MSI) list and EI is the Edge interfaces (EI) list. Since the Multicast Subscribers interfaces (MSI) list and the Edge interfaces list (EI) were obtained at block 402, a Query Interface (QI) List, which is a list of network device interfaces for sending membership query packets, is determined from the MSI and EI lists. It is a UNION operation on a SET.

In other words, {QI}={MSI}U{EI}, where

### QI=>Query Interface List

### MSI=>Multicast Subscriber List

### EI=>Edge Interfaces List

The query packets are received at the network devices from the OpenFlow controller. To provide an illustration in the context of FIG. 1, MSI in this case would be a set of 116 (L1), 116 (L2), and 124 (L1); EI would be a set of 116 (11), 122 (L1), and 124 (L1). In this case, the QI list calculated would be 116 (L1), 116 (L2), 122 (L1), and 124 (L1).

At block 406, multicast module in the OpenFlow Controller sends out a PACKET_OUT open flow message to interfaces in the Query Interface (QI) list only (for example, 116 (L1), 116 (L2), 122 (L1), and 124 (L1)). A PACKET_OUT message has a multicast query (IGMP for IPv4 and MLD for IPv6) packet embedded in it and output action for a network device is to send out on the interface dictated by the OpenFlow controller.

At block 408, network devices 116, 122, and 124, which received a PACKET_OUT message, extract the query packet, and based on the output action, send out a query packet out of the right interface. To illustrate in the context of FIG. 1, network device 116 sends query out packet on interfaces L1 and L2. Similarly, network devices 122 and 124 send query packet out on interface L1.

At block 410, upon receipt of a query out packet, host computer systems 128 and 132, and host stack of network device 130 respond back by sending multicast group membership packets for their respective multicast groups. These responses are recognized and network devices 116 and 124 forward the received group membership packets to OpenFlow controller, which tracks the group membership as part of its multicast module.

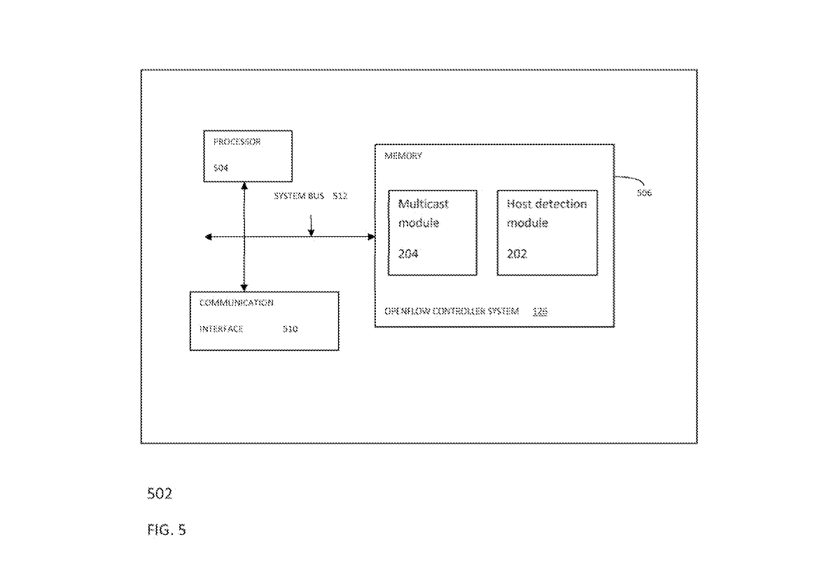

FIG. 5 is a schematic block diagram of an OpenFlow controller system hosted on a computer system, according to an example.

Computer system 502 may include processor 504, memory 506, message routing system 508 and a communication interface 510. OpenFlow controller system 126 includes host detection module 202 and multicast module 204. The components of the computing system 502 may be coupled together through a system bus 512.

Processor 504 may include any type of processor, microprocessor, or processing logic that interprets and executes instructions.

Memory 506 may include a random access memory (RAM) or another type of dynamic storage device that may store information and instructions non-transitorily for execution by processor 504. For example, memory 506 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 506 may include instructions that when executed by processor 504 implement OpenFlow controller system 126.

Communication interface 510 may include any transceiver-like mechanism that enables computing device 502 to communicate with other devices and/or systems via a communication link. Communication interface 510 may be a software program, a hard ware, a firmware, or any combination thereof. Communication interface 510 may use a variety of communication technologies to enable communication between computer system 502 and another computer system or device. To provide a few non-limiting examples, communication interface 510 may be an Ethernet card, a modem, an integrated services digital network (“ISDN”) card, etc.

OpenFlow controller system 126 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, OpenFlow controller system 126 may be read into memory 506 from another computer-readable medium, such as data storage device, or from another device via communication interface 510.

The proposed solution enables sending of query packet only to interfaces that connect to hosts and network infrastructure devices that are interested in multicasts instead of to all devices on the LAN. In the traditional approach of sending the query packets to all devices on the network, the controller needs to program a flow table entry matching the query packet on all the switches with appropriate action that will prevent the frames from going back to the controller via the default rule. With this approach, the need to program a new rule for every matching multicast query is not required.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in FIG. 5 are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of discovering multicast group memberships in a software defined network, comprising:
sending a multicast group membership query message only to a selected network device in the network;
forwarding the multicast group membership query message to a host computer system connected to the network device; and
recognizing, in response to the multicast group membership query message, a multicast group membership request from the host computer system.

2. The method of claim 1, wherein the selected network device is a network device interface which is connected to a host computer system.

3. The method of claim 2, wherein identifying the network device which is connected to a host computer system comprises using Link Layer Discovery Protocol (LLDP).

4. The method of claim 1, wherein the selected network device is a network device which receives a multicast group membership request from a host computer system.

5. The method of claim 1, wherein the multicast group membership query message is sent by an OpenFlow controller.

6. The method of claim 1, wherein the multicast group membership query message is sent at a periodic interval.

7. A system, comprising:
an OpenFlow controller, wherein the OpenFlow controller, comprises:
a host detection module to identify Edge interfaces in a software defined network; and
a multicast module to identify network device interfaces interested in receiving a multicast traffic,
wherein the OpenFlow controller identifies network devices for receiving a multicast group membership query message based on said Edge interfaces and said network device interfaces.

8. The system of claim 7, wherein the OpenFlow controller sends the multicast membership query message only to the identified network devices.

9. The system of claim 8, wherein the OpenFlow controller sends the multicast membership query message to the identified network devices at a periodic interval.

10. The system of claim 9, wherein the periodic interval is user defined.

11. The system of claim 7, wherein the identified network devices forward the multicast group membership query message to a respective host computer system and recognize, in response to the multicast group membership query message, multicast group membership requests from the respective host computer system.

12. The system of claim 7, wherein the network device interfaces interested in receiving a multicast traffic are network device interfaces that received a multicast group membership request from a host computer system.

13. The system of claim 7, wherein the multicast module maintains a database of the network device interfaces that received a multicast group membership request from a host computer system.

14. The system of claim 7, wherein the host detection module maintains a record of the Edge interfaces in the network.

15. A non-transitory processor readable medium, the non-transitory processor readable medium comprising machine executable instructions, the machine executable instructions when executed by a processor causes the processor to:
to identify Edge interfaces in a software defined network;
to identify network device interfaces interested in receiving a multicast traffic; and
to identify network devices for receiving a multicast group membership query message based on said Edge interfaces and said network device interfaces.
